(19) United States
(12) Patent Application Publication
(10) Pub. No.: US 2024/0315925 A1
(43) Pub. Date: Sep. 26, 2024

(54) VIAL ADAPTOR

(71) Applicant: Alveo Technologies, Inc., Alameda, CA (US)

(72) Inventors: Daniel Jordan Wade, San Ramon, CA (US); Aman Adam Ullah, Moraga, CA (US)

(21) Appl. No.: 18/612,911

(22) Filed: Mar. 21, 2024

Related U.S. Application Data
(60) Provisional application No. 63/491,931, filed on Mar. 23, 2023.

(51) Int. Cl. A61J 1/20

(52) U.S. Cl. CPC A61J 1/2096; A61J 1/2048

(57) ABSTRACT

A vial adaptor is disclosed. The vial adaptor can include a cap and a piston. The cap can removably couple to a vial storing, for example, liquid constituent for facilitating sample collection for detecting pathogens. The piston can distally translate through the cap and into the vial to generate volume displacement and positive pressure, which can cause the liquid constituent stored in the vial to flow out from the vial via a channel formed within the piston. The piston can include a seal that creates a water-tight barrier with an inner surface of the vial. In certain approaches, the piston may translate as a result of rotating the piston.

### INCORPORATION BY REFERENCE TO ANY PRIORITY APPLICATIONS

This application claims the benefit of U.S. Provisional Application 63/491,931, filed on Mar. 23, 2023, entitled “VIAL ADAPTOR”, which is hereby expressly incorporated by reference in its entirety.

### FIELD

The present application is generally related to a vial adaptor for transferring materials, such as a fluid containing a biological sample, from a vial to another device, for example a cartridge for sensing and/or identifying pathogens, genomic materials, proteins, and/or other small molecules or biomarkers.

### BACKGROUND

Pathogens may be identified by detecting genomic material (DNA or RNA) in a biological sample. In conventional nucleic acid amplification testing (“NAAT”), DNA in a biological sample is exponentially copied using a molecular amplification processes, for example the polymerase chain reaction (“PCR”) or Loop-Mediated Isothermal Amplification (“LAMP”), until the quantity of DNA present is great enough to be measurable. In the case of RNA, the genomic material of many viruses, an additional step can be included to first transcribe the RNA into DNA before amplification. Liquid constituents such as amplification reagents, buffer solutions, water, mucin mitigating agents, or other desired liquid constituents are typically used in the testing processes, some of which assist in extracting the DNA, RNA or both from a target agent present in the biological sample, for example mold, fungus, bacteria, virus, or a microbe. These liquid constituents need to be efficiently introduced into devices that facilitate NAAT, especially in situations where pipettes are not readily available. There is a lasting need for improved pathogen detection methods and tools, which facilitate the transfer of biological samples and liquid constituents into devices that are used for NAAT.

### SUMMARY

According to one aspect of the disclosure, a vial adaptor that can facilitate transfer of fluid from a vial to a receiving device is disclosed. The vial adaptor can include a cap comprising a proximal opening, a distal opening, and a threaded portion that can removably couple with a corresponding threaded portion formed on an opening of a vial; a piston including a cover, a distal end, a proximal end, a channel, and a body extending between the distal end and the proximal end and comprising a head, the cover can surround the head and abut an inner surface of the vial, the channel extending between the distal end and the proximal end of the piston and configured to allow flow of fluid through the piston between the distal end and the proximal end; a ratchet system including: a first arm formed about the proximal opening of the cap, at least a portion of the first arm extending inward towards a center of the proximal opening of the cap, the first arm including a tip; and a first rack formed along the body of the piston, the first rack can engage the first arm, wherein the engagement between the first rack and the first arm allows the piston to translate in a first direction, and wherein a translation of the piston in the first direction can cause a positive pressure change in the vial and withdrawal of fluid stored in the vial through the channel of the piston.

In some embodiments, the first direction can be a direction towards the vial.

In some embodiments, the engagement between the first rack and the first arm can prevent the piston from translating in a second direction.

In some embodiments, the second direction can be a direction away from the vial.

In some embodiments, the channel can include a proximal aperture and a distal aperture, the channel extending between the proximal aperture and the distal aperture, the distal aperture formed on a distal portion of the head of the body of the piston, the proximal aperture formed about the proximal end of the piston. The cover can include an opening that aligns with the proximal aperture of the channel, and wherein the fluid stored in the vial flows into the piston via the opening of the cover and the proximal aperture of the channel.

In some embodiments, an outer circumference of the cover can create a seal with the inner surface vial. The cover can be a molded elastomer.

In some embodiments, the first rack includes a plurality of teeth, and wherein each of the plurality of teeth includes a leading edge and a stopping edge. The leading edges of the first rack facilitates movement of the first arm, and wherein the stopping edges of the first rack prevents movement of the first arm. The first arm slides along the leading edges of the first rack when the piston is translated in the first direction, and wherein the first arm abuts against one of the stopping edges of the first rack when the piston is translated in the second direction.

In some embodiments, the proximal end of the piston removably can couple with a receiving device.

In some embodiments, the piston can include a stopper extending radially and circumferentially outwards from the body of the piston, wherein the stopper can abut the cap when the piston is in its distal-most position with respect to the cap.

In some embodiments, a width of the channel can increase from the distal end of the piston to the proximal end of the piston.

In some embodiments, the tip of the first arm can be curved inwards towards an axis orthogonal to the proximal opening and the distal opening.

In some embodiments, the vial adaptor can include: a second arm; and a second rack formed along the body of the piston and configured to engage the second arm. The second arm can be positioned opposite of the first arm, and wherein the second rack can be formed on an opposite side of the body of the piston.

According to another aspect of the disclosure, a vial adaptor is disclosed. The vial adaptor can include: a cap that can removably couple with an opening of a vial; and a piston including a distal end, a proximal end, a body extending between the distal end and the proximal end, and a channel, the channel can allow flow of fluid through the piston between a distal aperture formed on the distal end of the piston and a proximal aperture formed on the proximal end of the piston, the piston can translate distally through the cap and towards the vial; wherein a distal translation of the piston can cause a positive pressure change in the vial and withdrawal of fluid stored in the vial through the channel of the piston.

In some embodiments, the cap can include an arm, wherein the piston can include a rack, and wherein the arm can engage the rack to allow the piston to translate distally through the cap towards the vial and prevent the piston to translate proximally through the cap away from the vial. The arm can include a tip, and wherein the tip can be curved inwards towards an axis parallel to the body of the piston. The rack can include a plurality of teeth, wherein each of the plurality of teeth can include a leading edge and a stopping edge, and wherein the arm can slide along the leading edges of the plurality of teeth and the piston can be translated distally and abut one of the stopping edges of the plurality of teeth to prevent the piston from translating proximally.

In some embodiments, the proximal end of the piston can be removably coupled with a receiving device.

In some embodiments, the piston can include a stopper extending radially and circumferentially outwards from the body of the piston, wherein the stopper can abut the cap when the piston is in its distal-most position with respect to the cap.

In some embodiments, a width of the channel can increase from the distal aperture to the proximal aperture.

In some embodiments, the tip of the first arm can be curved inwards towards an axis orthogonal to the proximal opening and the distal opening.

In some embodiments, the vial adaptor can include a cover, wherein the cover can cover the distal end of the body of the piston. The cover can be a molded elastomer. The cover can abut an inner surface of the vial to create a seal between the cover and the inner surface of the vial.

According to another aspect of the disclosure, a piston for withdrawing fluid stored in a vial is disclosed. The piston can include: a distal end; a proximal end; a body extending between the distal end and the proximal end, the body including a head including a distal aperture, the proximal end including a proximal aperture; a channel formed within the body and extending between the distal aperture and the proximal aperture; the head of the piston that can move towards and into a vial and generate a positive pressure change in the vial, thereby causing a flow of fluid stored in the vial into the channel via the distal aperture and out of the channel via the proximal aperture.

In some embodiments, a width of the channel increases from the distal aperture to the proximal aperture.

In some embodiments, the piston can include a rack comprising a plurality of teeth. The rack can be formed along a length of the body of the piston. Each of the plurality of teeth can include a leading edge and a stopping edge. The leading edges of the plurality of teeth can allow an arm of a cap to slide along in a first direction, and wherein the stopping edges of the plurality of teeth can prevent the arm of the cap from moving in a second direction opposite from the first direction.

In some embodiments, the piston can move through a proximal opening and a distal opening of a cap, and wherein the cap can be attached to an opening of the vial.

In some embodiments, the cap can be positioned between the piston and the vial.

In some embodiments, the piston can include a cover. The cover can cover the distal end of the piston, and wherein an outer circumference of the cover can abut an inner surface of the vial to create a seal between the cover and the vial. The cover can be a molded elastomer.

In some embodiments, the proximal end of the piston can removably couple with a receiving device.

According to another aspect of the disclosure, a method of withdrawing fluid stored in a vial via a vial adaptor is disclosed. The method can include: coupling a distal opening of a cap of a vial adaptor to an opening of a vial, the cap including a proximal opening opposite of the distal opening; coupling a proximal end of a piston of the vial adaptor to an opening of a receiving device; distally translating the piston towards the vial and through the proximal opening and the distal opening of the cap, a head of the piston can abut an inner surface of the vial to create a water-tight seal between the head of the piston and the inner surface of the vial, a distal translation of the piston towards the vial can generate positive pressure change in the vial and cause a flow of fluid stored in the vial.

In some embodiments, the head of the piston can be a molded elastomer.

In some embodiments, the cap can include an arm and the piston can include a rack having a plurality of teeth, and wherein the arm of the cap and the plurality of teeth of the piston can engage during the distal translation of the piston.

In some embodiments, each of the plurality of teeth of the rack can include a leading edge and a stopping edge, wherein the arm slides along the leading edges of the plurality of teeth of the rack during the distal translation of the piston, and wherein the stopping edges of the plurality of teeth of the rack can prevent a proximal translation of the piston away from the vial.

In some embodiments, the piston can include a channel extending between a distal aperture formed about a distal end of the piston and a proximal aperture formed about the proximal end of the piston.

In some embodiments, the piston can include a stopper. The stopper can abut the cap when the piston is in its distal-most position. The stopper can abut the receiving device when the proximal end of the piston is coupled to the opening of the receiving device.

According to another aspect of the disclosure, a vial adaptor configured to facilitate transfer of fluid from a vial to a receiving device is disclosed. The vial adaptor can include: a cap including a proximal opening, a distal opening, at least one detent, and a threaded portion that can removably couple with a corresponding threaded portion formed on an opening of a vial; a piston including a distal end, a proximal end, a channel, and a body extending between the distal end and the proximal end and comprising a head, the piston capable of abutting an inner surface of the vial, the channel extending between the distal end and the proximal end of the piston and configured to allow flow of fluid through the piston between the distal end and the proximal end, the body including a groove configured to contact the at least one detent, the groove configured to cause the piston to translate in a first direction relative to the cap when the piston is rotated relative to the cap, translation of the piston in the first direction configured to cause a positive pressure change in the vial and withdrawal of fluid stored in the vial through the channel of the piston.

In some embodiments, the first direction is a direction towards the vial.

In some embodiments, the groove includes one or more locks configured to secure the piston in place relative to the cap. In further embodiments, the one or more locks include a first lock, the first lock configured to lock the piston at a first position relative to the cap and a second lock, the second lock configured to lock the piston at a second position relative to the cap. In further embodiments, the first position is a pre-actuation position and the second position is a post-actuation position. In further embodiments, any of the one or more locks include a ridge within the groove.

In some embodiments, the piston includes a seal configured to abut an interior surface of the vial. In some embodiments, the seal includes an elastomer.

In some embodiments, the proximal end of the piston is configured to removably couple with a receiving device.

In some embodiments, the piston includes a stopper extending radially and/or circumferentially outwards from the body of the piston, where the stopper is configured to abut the cap when the piston is in its distal-most position with respect to the cap.

In some embodiments, a width of the channel increases from the distal end of the piston to the proximal end of the piston.

According to another aspect of the disclosure, a vial adaptor is disclosed. The vial adaptor can include: a cap that can removably couple with an opening of a vial; and a piston including a distal end, a proximal end, a body extending between the distal end and the proximal end, and a channel, the channel configured to allow flow of fluid through the piston between a distal aperture formed on the distal end of the piston and a proximal aperture formed on the proximal end of the piston, the piston configured rotate and thereby translate distally through the cap and towards the vial; where a distal translation of the piston is configured to cause a positive pressure change in the vial and withdrawal of fluid stored in the vial through the channel of the piston.

In some embodiments, the cap includes a detent, wherein the piston includes a groove, and wherein the detent is configured to engage the groove to allow rotation of the piston relative to the cap to cause distal translation of the piston through the cap towards the vial.

In some embodiments, the groove includes a first lock, the first lock configured to prevent motion of the piston relative to the cap absent a threshold force imparted by a user. In further embodiments, the groove includes a second lock, wherein the first lock is configured to secure the piston in a pre-actuation position absent a threshold force imparted by the user, and wherein the second lock is configured to secure the piston in a post-actuation position and configured to provide a user with tactile feedback that actuation of the piston is complete.

In some embodiments, the proximal end of the piston is configured to removably couple with a receiving device.

In some embodiments, the piston includes a stopper extending radially and circumferentially outwards from the body of the piston, wherein the stopper is configured to abut the cap when the piston is in a post-actuation position with respect to the cap.

In some embodiments, a width of the channel increases from the distal aperture to the proximal aperture.

In some embodiments, further including a seal, wherein the seal is configured to wrap about at least a portion of the distal end of the body of the piston.

In some embodiments, the seal includes an o-ring, the o-ring including an elastomer.

In some embodiments, the seal is configured to abut an inner surface of the vial to create a watertight barrier between the seal and the inner surface of the vial.

According to another aspect of the disclosure, a piston for withdrawing fluid stored in a vial is disclosed. The piston can include: a distal end; a proximal end; a body extending between the distal end and the proximal end, the body including a head including a distal aperture, the proximal end including a proximal aperture; a channel formed within the body and extending between the distal aperture and the proximal aperture; and a groove formed on an exterior surface of the body and extending along at least a portion of the length of the body, the groove configured to contact a detent; the head of the piston configured to move towards and into a vial and generate a positive pressure change in the vial, thereby causing a flow of fluid stored in the vial into the channel via the distal aperture and out of the channel via the proximal aperture.

In some embodiments, a width of the channel increases from the distal aperture to the proximal aperture.

In some embodiments, the groove spirals about at least a portion of the circumference of the body. In further embodiments, wherein the groove includes a lock. In further embodiments, the lock includes a ridge positioned within the groove.

In some embodiments, the piston is configured to move through a proximal opening and a distal opening of a cap, and wherein the cap is configured to be attached to an opening of the vial.

In some embodiments, the piston includes a seal. In further embodiments, the seal is configured to cover at least a portion of the distal end of the piston, and wherein an outer circumference of the seal is configured to abut an inner surface of the vial thereby create a watertight barrier between the seal and the vial. In further embodiments, the seal includes an elastomer.

In some embodiments, the proximal end of the piston is configured to removably couple with a receiving device.

According to another aspect of the disclosure, a method of withdrawing fluid stored in a vial via a vial adaptor is disclosed. The method can include: coupling a distal opening of a cap of a vial adaptor to an opening of a vial, the cap including a proximal opening opposite of the distal opening; coupling a proximal end of a piston of the vial adaptor to an opening of a receiving device; rotating the piston relative to the cap and the vial, thereby causing distal translation of the piston towards the vial and through the proximal opening and the distal opening of the cap, the piston configured to abut an inner surface of the vial to create a watertight barrier between the piston and the inner surface of the vial, the distal translation of the piston towards the vial thereby generating a positive pressure change in the vial causing a flow of fluid stored in the vial through a channel of the piston.

In some embodiments, the piston includes a seal, the seal covering at least a portion of a distal end of the piston.

In some embodiments, the cap includes a detent and the piston include a groove configured to engage the detent, and wherein rotation of the piston causes the detent to travel along a path defined by the groove, thereby causing distal translation of the piston relative to the cap.

In some embodiments, the method includes rotating the piston past a pre-actuation position, where, at the pre-actuation position, the detent is engaged by a first lock.

In some embodiments, the method includes rotating the piston to a post-actuation position, wherein, at the post-actuation position, the detent is engaged by a second lock.

In some embodiments, the channel extends between a distal aperture formed about a distal end of the piston and a proximal aperture formed about the proximal end of the piston.

In some embodiments, the piston includes a stopper. In further embodiments, the stopper is configured to abut the cap when the piston is in its post-actuation position. In some embodiments, the stopper is configured to abut the receiving device when the proximal end of the piston is coupled to the opening of the receiving device.

### BRIEF DESCRIPTION OF THE DRAWINGS

FIGS. 1A and 1B illustrate various views of an example vial adaptor including a ratchet system coupled to a vial.

FIG. 2 illustrates an exploded view of the vial adaptor of FIGS. 1A and 1B, showing various components of the vial adaptor.

FIG. 3 illustrates a perspective view of the vial adaptor of FIGS. 1A and 1B.

FIG. 4A illustrates a perspective view of a piston portion of the vial adaptor of FIGS. 1A and 1B without a cap portion.

FIG. 4B illustrates the piston portion of FIG. 4A showing a tip separated from a piston body.

FIG. 5A illustrates a cross-sectional view of the syringe portion of FIG. 4A along the lines 5A-5A.

FIG. 5B illustrates a cross-sectional view of the syringe portion of FIG. 4B along the lines 5B-5B.

FIGS. 6A and 6B illustrate various views of a cap portion of the vial adaptor of FIGS. 1A and 1B.

FIG. 7A illustrates a cross-sectional view of the vial adaptor of FIGS. 1A and 1B prior to actuation of a piston of the vial adaptor.

FIG. 7B illustrates a cross-sectional view of the vial adaptor of FIGS. 1A and 1B during actuation of a piston of the vial adaptor.

FIG. 7C illustrates a cross-sectional view of the vial adaptor of FIGS. 1A and 1B showing a piston of the vial adaptor in its distal-most position.

FIG. 8A illustrates the vial adaptor of FIGS. 1A and 1B and a receiving device.

FIG. 8B illustrates the vial adaptor of FIGS. 1A and 1B coupled to a receiving device.

FIG. 9 illustrates an example method of transferring fluid from a vial to a receiving device using the vial adaptor of FIGS. 1A and 1B.

FIGS. 10A and 10B illustrate various views of an example vial adaptor including a rotating piston coupled to a vial.

FIG. 11 illustrates an exploded view of the vial adaptor of FIGS. 10A and 10B, showing various components of the vial adaptor.

FIG. 12 illustrates a perspective view of the vial adaptor of FIGS. 10A and 10B.

FIG. 13A illustrates a perspective view of a piston portion of the vial adaptor of FIGS. 10A and 10B.

FIG. 13B illustrates the piston portion of FIG. 13A showing a seal separated from a piston body.

FIG. 14A illustrates a cross-sectional view of the syringe portion of FIGS. 13A and 13B along the lines 14A-14A.

FIG. 14B illustrates a cross-sectional view of the syringe portion of FIG. 4B along the lines 14B-14B.

FIGS. 15A and 15B illustrate various views of a cap portion of the vial adaptor of FIGS. 10A and 10B.

FIG. 16A illustrates a cross-sectional view of the vial adaptor of FIGS. 10A and 10B prior to actuation of a piston of the vial adaptor.

FIG. 16B illustrates a cross-sectional view of the vial adaptor of FIGS. 10A and 10B during actuation of a piston of the vial adaptor.

FIG. 16C illustrates a cross-sectional view of the vial adaptor of FIGS. 10A and 10B showing a piston of the vial adaptor in its distal-most position.

FIG. 17A illustrates the vial adaptor of FIGS. 10A and 10B and a receiving device.

FIG. 17B illustrates the vial adaptor of FIGS. 17A and 17B coupled to a receiving device.

FIG. 18 illustrates an example method of transferring fluid from a vial to a receiving device using the vial adaptor of FIGS. 10A and 10B.

### DETAILED DESCRIPTION

Aspects of the disclosure herein concern an adaptor that facilitates the flow of liquid constituents from a standard vial to a target sensing device or a diagnostic device e.g., a cartridge configured to detect a pathogen. The adaptor may be coupled to a standard vial and a standard target sensing device without any modification to the vial or the target sensing device. In some aspects, the adaptor is configured to inhibit or prevent re-aspiration of the liquid constituent into the vial.

### Vial Adapter Including Ratchet Piston

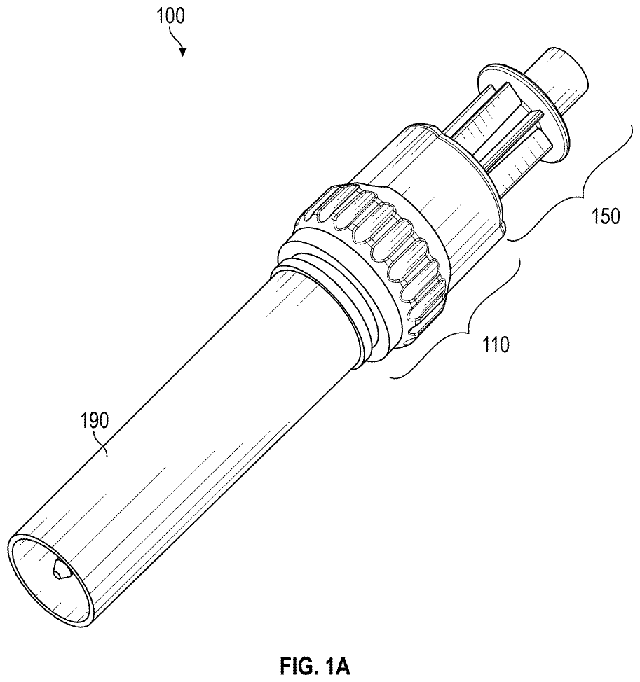

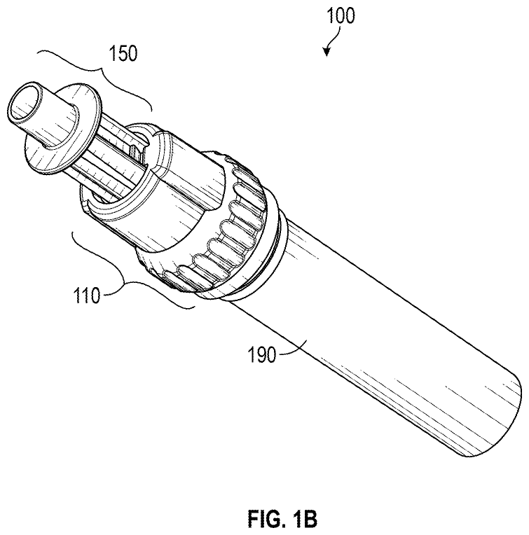

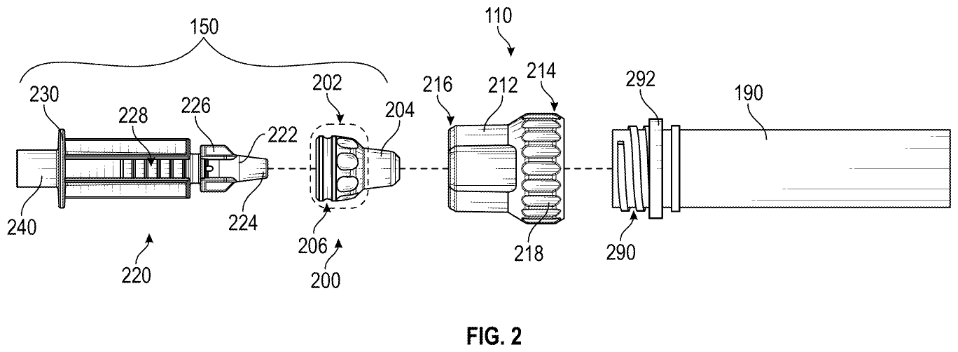

FIGS. 1A and 1B illustrate various views of an example vial adaptor 100. The vial 190 can be, in some embodiments, an off-the-shelf vial or the vial can be specifically or custom manufactured. The adaptor 100 can include a cap 110 and a piston 150. The cap 110 can be removably coupled to a vial 190 during use and can be decoupled after use. For example, the vial 190 can include a threaded or interlocking portion 290 (an example is shown in FIG. 2), which corresponds to a threaded or interlocking portion 620 of the cap 110. The piston 150 can be slidingly inserted into a cavity formed by the cap 110 and translate towards the vial 190 through the cap 110. In some embodiments, the cap 110 can include a locking mechanism that allows the piston 150 to only translate distally (for example, towards the vial 190) and not proximally (for example, away from the vial 190). The movement of the piston 150 (for example, distal translation through the cap 110 towards the vial 190) can generate a positive pressure and/or cause fluid stored in the vial 190 to flow out of the vial 190 through the vial adaptor 100.

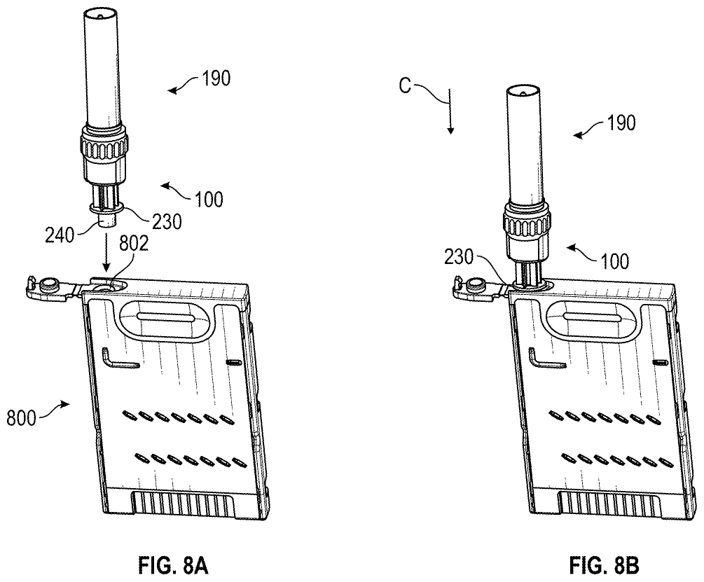

The piston 150 can include a proximal end (for example, an end opposite the vial 190 as shown in FIG. 1A) that can removably couple with an opening of a target sensing device or a diagnostic device (for example, see FIGS. 8A and 8B).

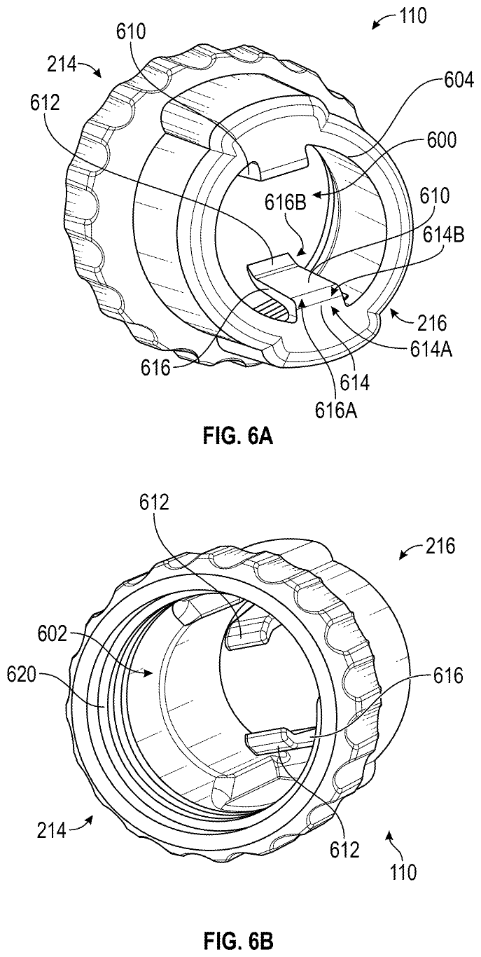

FIG. 2 illustrates an exploded view of the vial adaptor 100 and the vial 190. The cap 110 can include a distal end 214 (for example, an end that is proximate to the vial 190) and a proximal end 216 (for example, an end that is distal from the vial 190). The proximal end 216 can include an opening dimensioned to receive the piston 150. The distal end 214 can include an opening dimensioned to couple with the vial 190. For example, the distal end 214 of the cap 110 can include an inner surface having the threaded or interlocking portion 620 (see FIG. 6B). Additionally, the distal end 214 of the cap 110 can extend over at least a portion of the threaded portion 290 of the vial 190 when coupled to the vial 190. The coupling between the vial 190 and the cap 110 can be leak-proof to prevent or inhibit fluid stored in the vial 190 from leaking during the transfer process.

The vial 190 can include the threaded portion 290 and a protrusion 292. The protrusion 292 can engage the distal end 214 of the cap 110 and stop further distal translation of the cap 110.

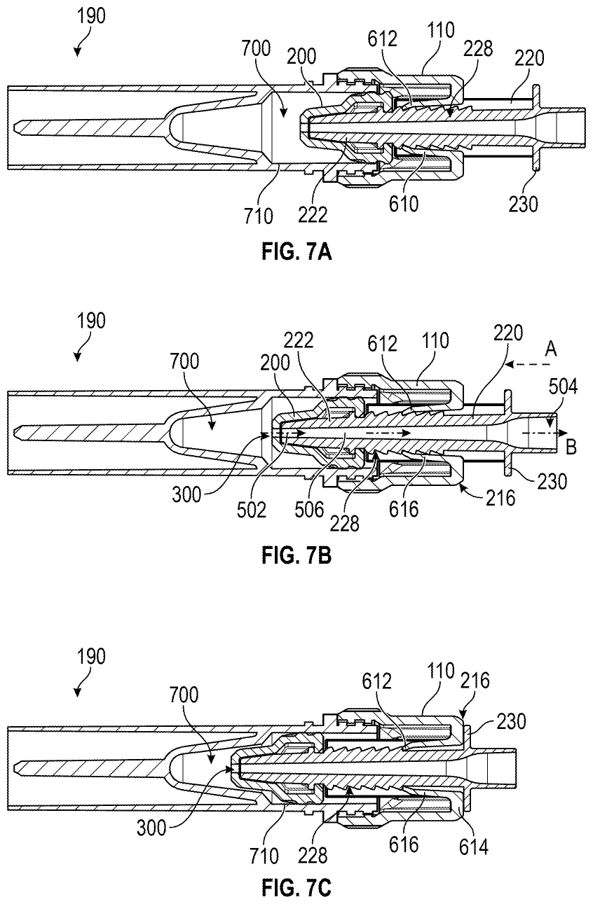

The piston 150 can include a cover 200 and a body 220. The cover 200 and the piston body 220 can be removably coupled. The cover 200 can include a base 202 and a tip 204. The base 202 that can be dimensioned such that its outer circumference 206 can abut against an inner surface (for example, inner surface 710 shown in FIG. 7A) of the vial 190 to create a seal. The seal between the inner surface 710 of the vial 190 and the outer circumference 206 of the base 202 can be maintained while the piston 150 is distally translated through the cap 110 towards the vial 190. Additionally, the seal between the inner surface 710 of the vial 190 and the outer circumference 206 of the base 202 can prevent or inhibit fluid stored in the vial 190 from leaking between the base 202 of the cover 200 and the inner surface 710 of the vial 190 during use. Additionally, the seal between the inner surface 710 of the vial 190 and the outer circumference 206 of the base 202 can generate a positive pressure gradient or volume displacement in the vial 190, which can cause fluid stored in the vial 190 to flow out of the vial 190 via the vial adaptor 100.

In some embodiments, the cover 200 is made from a material that can generate desired amount of friction against the inner surface 710 of the vial 190 (for example, inner surface 710 shown in FIG. 7A). The friction between the cover 200 and the inner surface 710 of the vial 190 can prevent or inhibit accidental distal translation of the piston 150. In some embodiments, the cover 200 is a molded elastomer.

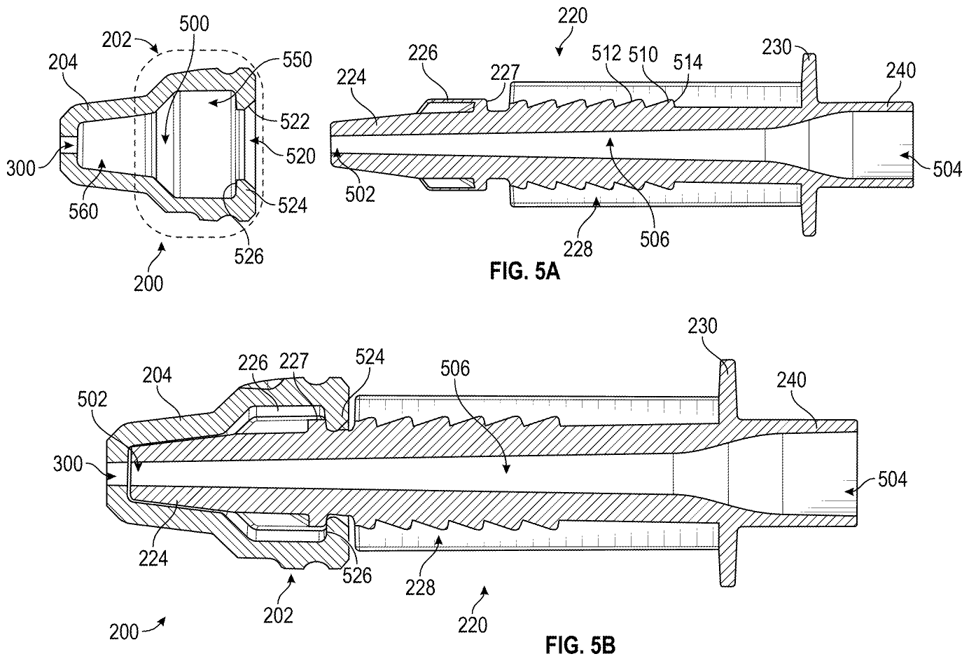

The body 220 of the piston 150 can include a head 222, one or more sets of racks 228, a stopper 230, and a proximal portion 240. The head 222 can include one or more flaps 226 and a distal end 224. The head 222 can be positioned inside the cover 200 (for example, in a cavity 500 as shown in FIG. 5A) when the head 222 is coupled with the cover 200. The flaps 226 can each include a rear edge 227 that can abut against an inner surface of the cover 200 and prevent the cover 200 from slipping off of the head 222. The distal end 224 can be shaped such that when the head 222 is inserted into the cavity 500 of the cover 200, the tip 204 and its inner surface wraps about an outer surface of the distal end 224 (for example, as shown in FIG. 5B). This can provide a desired seal between the cover 200 and the head 222 (for example, an inner surface of the tip 204 and an outer surface of the distal end 224) that can prevent or inhibit flow of, for example, fluid stored in the vial 190 into an area between the cover 200 and the head 222 during use.

The racks 228 can be formed on the body 220. For example, the racks 228 can be formed along a longitudinal axis defined by the length of the body 220 (as shown in FIGS. 5A and 5B). The racks 228 can include teeth 510 that can engage corresponding arms (for example, arms 610 shown in FIGS. 6A and 6B) of the cap 110 to restrict the movement of the piston 150 through the cap 110. The racks 228 and the corresponding arms (for example, the arms 610) of the cap 110 can be a locking mechanism that restricts the movement of the piston 150 through the cap 110.

The stopper 230 can extend radially outward from an outer circumference of the body 220 proximate to the proximal portion 240. The stopper 230 can engage the proximal end 216 of the cap 110 to prevent further movement (for example, distal translation) of the piston 150 with respect to the cap 110 (for example, through the cap 110). Additionally, the stopper 230 can abut against an opening of a testing device (e.g., a cartridge for sensing and/or identifying pathogens, genomic materials, proteins, and/or other small molecules or biomarkers) or another storage device (for example, for fluid samples) during use such that fluid stored in the vial 190 can be transferred to the testing device or the other storage device via the vial adaptor 100.

In some embodiments, the piston 150 can only translate distally (for example, towards the vial 190) and cannot translate proximally (for example, away from the vial 190). The movement of the piston 150 with respect to the cap 110 is further described herein.

In some embodiments, the piston 150 and the cap 110 may be integrated into a single device, while the piston 150 being able to move (for example, translate distally or proximally) with respect to the cap 110.

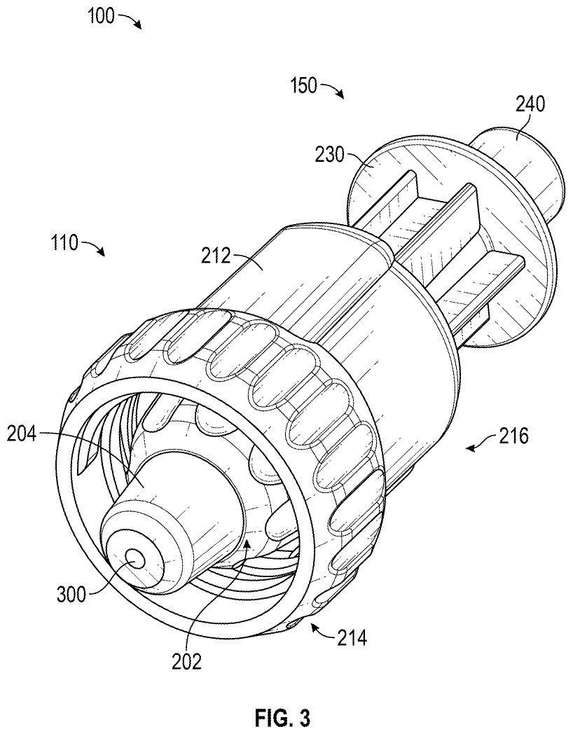

FIG. 3 illustrates a perspective view of the vial adaptor 100. The cover 200 can include a distal aperture 300 formed on a distal end of the tip 204. During use, as the piston 150 distally translates towards the vial 190, the cover 200 and the distal aperture 300 can move, for example, into a cavity 700 (see FIGS. 7A-7C) of the vial 190. As the cover 200 moves into the cavity (for example, the cavity 700) of the vial 190, it displaces the volume of the cavity and generates a positive pressure change in the vial 190. Coupled with the seal between the cover 200 and the inner surface (for example, the inner surface 710) of the vial 190, the distal movement of the piston 150 (and the cover 200) can cause flow of fluid stored in the vial 190 via the distal aperture 300 and out of the vial 190 via the vial adaptor 100. In some embodiments, at least a portion of the cover 200 and the distal aperture 300 extends into a portion of the vial 190.

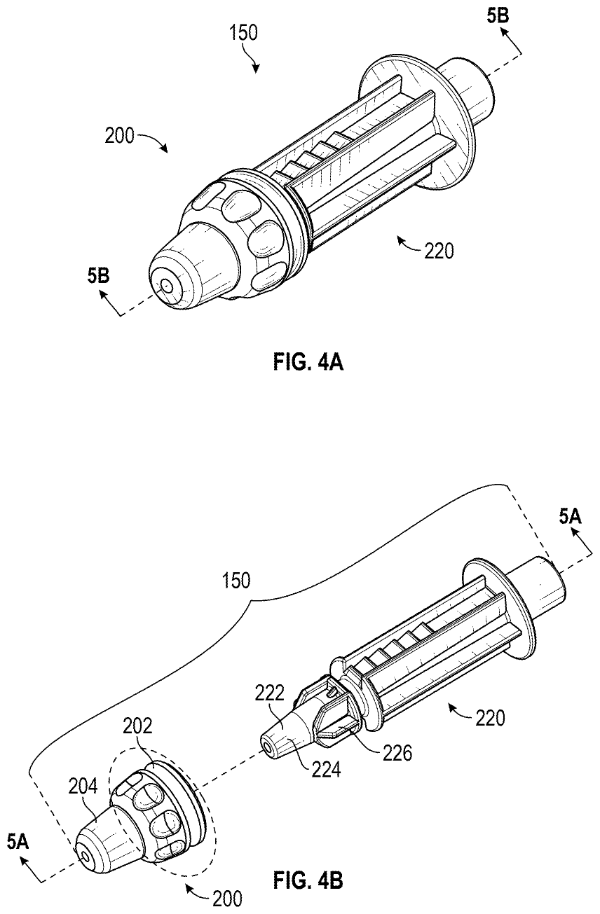

With references to FIGS. 4A-5B, the cover 200 can be removably coupled with head 222 of the body 220. The cover 200 can include the cavity 500 (see FIGS. 5A and 5B) formed inside the tip 204 and the base 202. The shape of the cavity 500 can correspond to the shape of the head 222 of the body 220 such that the head 222 can be inserted within the cavity 500 of the cover 200 without much clearance. This can prevent the head 222 from slipping away from the cover 200 or the cover 200 slipping off from the head 222.

The cavity 500 can include a first portion 550 and a second portion 560. The first portion 550 can be a space circumferentially surrounded by an inner surface of the base 202. The first portion 550 can receive the flaps 226 of the head 222. The second portion 560 can be a space circumferentially surrounded by an inner surface of the tip 204. The second portion 560 can be narrower than the first portion 550. As described herein, the second portion 560 can receive the distal end 224 of the head 222.

The cover 200 can include a lip 524 that is circumferentially formed at a proximal end of the cover 200 and forming a proximal aperture 520 of the cover 200. The lip 524 can extend inwards towards the center of the proximal aperture 520 from the body of the base 202 such that the end of the lip 524 defines the proximal aperture 520. The proximal aperture 520 may be circular or some other desired shape. The lip 524 can include a tapered edge 522 that can facilitate and guide insertion of the head 222 into the cavity 500 of the cover 200. Once the head 222 is inserted into the cavity 500 of the cover 200, a distal edge 526 of the lip 524 (for example, an edge of the lip 524 that faces towards the vial 190 during use) can abut the rear edge 227 of the flaps 226 to prevent the head 222 from slipping out from the cover 200.

The body 220 can include a distal opening 502, a proximal opening 504, and a channel 506 extending and formed between the distal opening 502 and the proximal opening 504. When the cover 200 is placed on the head 222 of the body 220, the distal opening 502 of the body 220 can substantially align with the distal aperture 300 of the cover 200, as shown in FIG. 5B. The gap between the cover 200 and the head 222 can be minimized to prevent any diverted flow into the gap between the cover 200 and the head 222.

In some embodiments, the width of the channel 506 can be uniform across the length of the piston 150 or vary along the length of the piston 150. For example, the width of the channel 506 can, as shown in FIGS. 5A and 5B, gradually increase from the distal opening 502 to the proximal opening 504. In another example, the width of the channel can remain substantially the same between the majority of the channel 506 between the distal opening 502 and the stopper 230, and increase significantly at the proximal portion 240. The gradual increase of the width of the channel 506 can facilitate flow through the channel 506.

As described herein and shown in FIG. 5A, the rack 228 can include teeth 510. The teeth 510 can be triangular in shape. The teeth 510 can each include a leading edge 512 and a stopping edge 514 that can facilitate and restrict movement of the piston 150 through the cap 110, respectively.

FIGS. 6A and 6B illustrate various views of the cap 110 of the vial adaptor 100. The cap 110 can include a proximal opening 600, a distal opening 602, an arm 610, and the threaded or interlocking portion 620. The proximal opening 600 can be dimensioned to receive the piston 150. The distal opening 602 can be dimensioned to, for example, extend over at least a portion of the vial 190 (for example, the threaded portion 290 of the vial 190). The threaded or interlocking portion 620 can be formed on an inner surface of the distal opening 602 and can couple with a corresponding threaded portion (for example, the threaded portion 290) of the vial 190. As described herein, the interaction between the threaded or interlocking portion 620 of cap 110 and the threaded or interlocking portion 290 of the vial 190 can allow the cap 110 of the vial adaptor 100 to removably couple with the vial 190.

The arm 610 can include a first portion 614 and a second portion 616. The first portion 614 can include a first end 614A coupled to an inner circumference 604 of the proximal opening 600 and a second end 614B at a predetermined distance away from the first end 614A. As shown in FIG. 6A, the first portion 614 can extend inwardly (for example, in a direction towards the center of the proximal opening 600) from the inner circumference 604 of the proximal opening 600 between the first end 614A and the second end 614B. The second portion 616 can extend distally (for example, in a direction away from the proximal opening 600 and towards the distal opening 602) from the second end 614B of the first portion 614. The second portion 616 can extend substantially orthogonally with respect to the first portion 614. The second portion 616 can include a first end 616A and a second end 616B, where the first end 616A is attached to the second end 614B of the first portion 614. The second end 616B can be a free end and include a detent 612 formed about the second end 616B of the second portion 616. The detent 612 can a curved end that is curved inwards and extending away from the second portion 616, for example, as shown in FIGS. 6A and 6B.

In some embodiments, the cap 110 can include more than one of the arm 610. For example, as shown in FIGS. 6A and 6B, the cap 110 can include two arms 610 that are positioned on opposite sides of the inner circumference 604. Alternatively, the two arms 610 can be positioned 90 degrees from one another or any other suitable angles. The detents 612 of the arms 610 can be curved towards each other.

FIGS. 7A-7C illustrate cross-sectional views of the vial adaptor 100, showing different positions of the piston 150 during use. FIG. 7A illustrates relative position of the piston 150 of the vial adaptor 100 with respect to the vial 190 and the cap 110 prior to actuation (for example, distal translation of the piston 150 towards the vial 190). Prior to actuation, at least a portion of the piston 150 (for example, the cover 200 and the head 222) may be positioned inside the vial 190. Additionally, the outer circumference of the cover 200 of the piston 150 can abut against the inner surface of the vial 190 to provide water-tight seal between the inner surface of the vial 190 and the cover 200. The water-tight seal can prevent or inhibit any flow of fluid stored in the vial 190 being diverted into a space between the cap 110 and the body 220 of the piston 150. In some embodiments, the detent 612 of the arms 610 of the cap 110 can abut against a distal-most tooth of teeth 510 of the rack 228 prior to actuation of the piston 150.

FIGS. 7B and 7C illustrates relative position of the piston 150 with respect to the vial 190 and the cap 110 during distal translation of the piston 150. As described herein, the piston 150 (or the body 220 of the piston 150) can be actuated and/or translated distally towards the vial 190 (for example, as indicated by a directional arrow A). When the piston 150 moves in the direction A, the cover 200 and the head 222 of the piston 150 moves further into the vial 190. This causes a positive pressure change and/or volume displacement in the vial 190, which causes a flow of fluid stored in the vial 190 out of the vial 190 via the distal aperture 300 of the cover 200, the distal opening 502, the channel 506, and the proximal opening 504 (for example, as indicated by directional arrows B). Additionally, when the piston 150 moves in the direction A (for example, moving distally towards the vial 190), the arm 610 of the cap 110 can move along the rack 228 towards the stopper 230 by sliding long the leading edges 512 of the teeth 510. Interacting together, the detents 612 and the teeth 510 may act as a ratchet system. The teeth 510 of the rack 228 can be shaped such that the arm 610 can move towards the stopper 230 (for example, by sliding along the leading edges 512) but not towards the head 222. When the piston 150 is pulled in a direction away from the vial 190 (for example, in a direction opposite of direction A as shown in FIG. 7B), the stopping edge 514 of the teeth 510 of the rack 228 can engage the detent 612 of the arm 610 to prevent or inhibit movement of the piston 150 being pulled away from the vial 190. This can prevent or inhibit negative volume displacement (that is, increase in the volume inside the vial 190) and decrease in pressure in the vial 190, which can lead to re-aspiration of, for example, fluid withdrawn from the vial 190.

When the piston 150 is fully actuated (for example, at its distal-most position with respect to the cap 110), the stopper 230 of the piston 150 can abut against the proximal end 216 of the cap. Additionally, the detent 612 of the arm 610 may or may not abut against the proximal-most tooth of teeth 510 of the rack 228 when the piston 150 is fully actuated.

With reference to FIGS. 8A and 8B, the vial adaptor 100 can be used to transfer, for example, fluid stored in the vial 190 to a receiving device 800. The proximal portion 240 of the piston 150 can be inserted into an opening 802 of the receiving device 800. To prevent accidental leak from the vial 190 via the vial adaptor 100, the vial 190 and the vial adaptor 100 can be oriented to have the vial 190 positioned below the vial adaptor 100 while the proximal portion 240 is being coupled to the opening 802 of the receiving device 800. In some embodiments, the proximal portion 240 and the opening 802 can be coupled via friction fit. In some embodiments, the proximal portion 240 and the opening 802 can have corresponding attachment features (for example, threads) that allow the proximal portion 240 and the opening 802 to be removably secured to each other.

Once the vial 190 and the vial adaptor 100 are coupled to the receiving device 800, the receiving device 800 can be positioned below the vial 190 and the vial adaptor 100. The piston 150 can then be translated towards the cap 110 by, for example, pushing the vial 190 and the cap 110 towards the receiving device 800. Pushing the vial 190 and the cap 110 towards the receiving device 800 can cause the cover 200 of the piston 150 to move towards or into the vial 190 to generate positive pressure and/or volume displacement in the vial 190. The positive pressure and/or volume displacement in the vial 190 can cause flow of, for example, fluid stored in the vial 190 to the receiving device 800.

### Method of Using Piston Including a Ratchet System

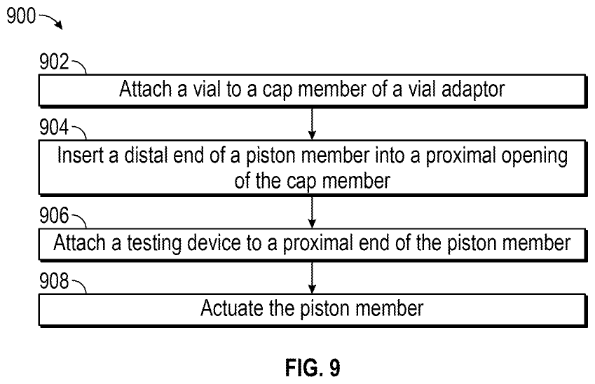

FIG. 9 illustrates an example method 900 of transferring fluid from a vial (for example, the vial 190) to a receiving device (for example, a testing device) using the vial adaptor 100. At step 902, a vial (for example, the vial 190) is attached to the cap 110 of the vial adaptor 100. For example, as described herein, the vial can include a threaded portion that can be screwed into the threaded or interlocking portion 620 of the cap 110. At step 904, the distal end (for example, the cover 200) of the piston 150 is inserted into the cap 110 via the proximal opening 600 (see FIG. 6A). In some embodiments, the piston 150 is integrated with the cap 110 while being able to, for example, translate distally towards the vial 190, and as such, the step 904 may be optional.

At step 906, an opening of a receiving device (for example, a testing device or a cartridge) is coupled to the proximal portion 240 of the piston 150. In some embodiments, the opening of the device and the proximal portion 240 can have corresponding coupling features (for example, threads, snap-fit, or a single thread and lock coupling) that allow the piston 150 to be removably secured to the opening of the receiving device. In some embodiments, the proximal portion 240 of the piston 150 can be coupled to the opening of the receiving device via friction fit. At step 908, the piston 150 is actuated. As described herein, the piston 150 may be actuated by distally translating towards the vial 190. When the piston 150 moves towards the vial 190, the movements of the cover 200 and the seal between the cover 200 and the inner surface of the vial 190 can generate positive pressure and/or volume displacement in the vial 190, which can in turn generate flow out of the vial 190 and into the piston 150. In some embodiments, in order to facilitate the flow out of the vial 190, into the piston 150, and into the receiving device, the vial 190, the vial adaptor 100, and the receiving device (for example, the receiving device 800) may be positioned as shown in FIGS. 8A and 8B.

The methods disclosed herein include one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

### Vial Adapter Including a Rotating Piston

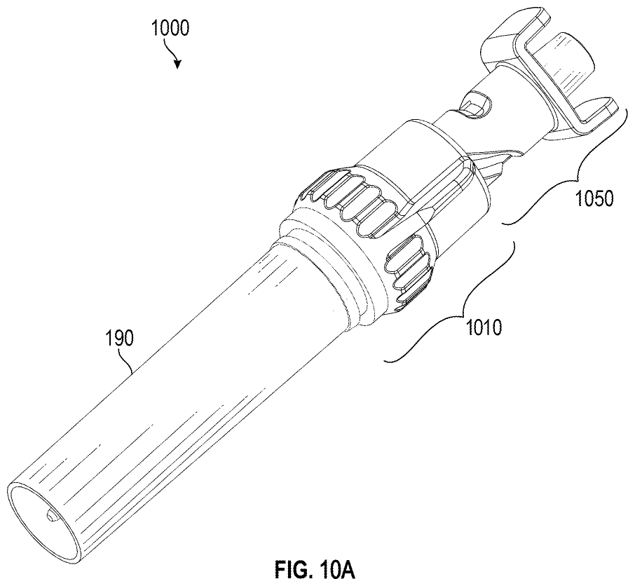

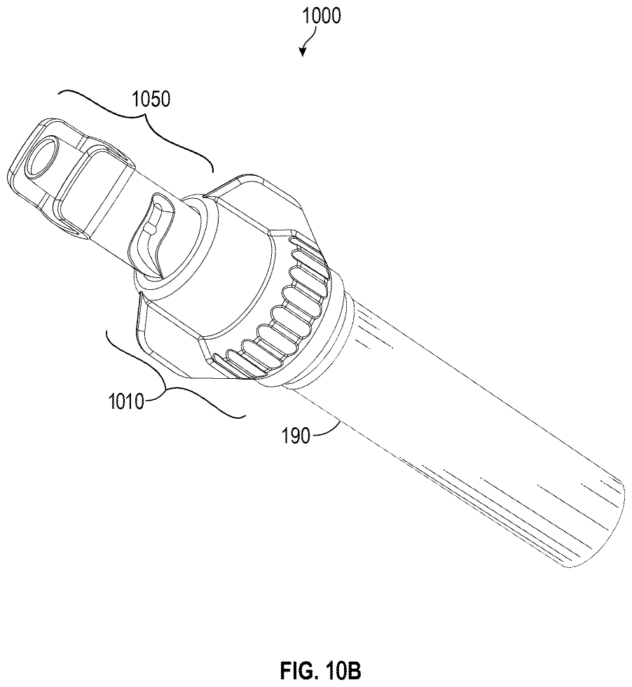

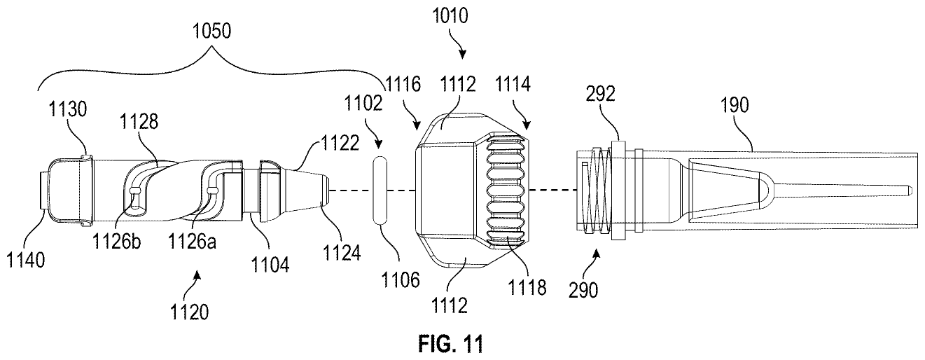

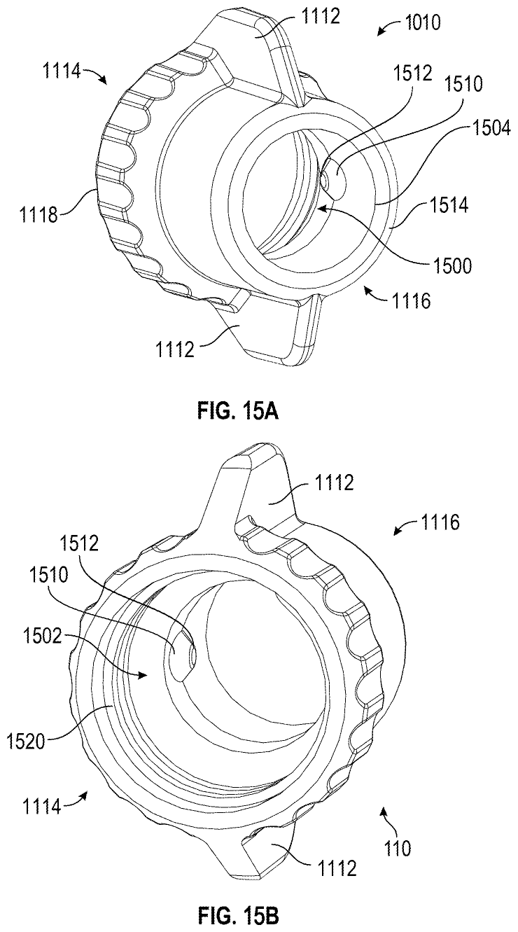

FIGS. 10A and 10B illustrate various views of an example vial adaptor 1000. The vial 190 can be, in some embodiments, an off-the-shelf vial or the vial can be specifically or custom manufactured. The vial adaptor 1000 can include a cap 1010 and a piston 1050. The cap 1010 can be removably coupled to a vial 190 during use and can be decoupled after use. For example, the vial 190 can include a threaded or interlocking portion 290 (an example is shown in FIG. 11), which corresponds to a threaded or interlocking portion 1520 (an example is shown in FIG. 15B) of the cap 1010. The piston 1050 can be slidingly inserted into a cavity formed by the cap 1010 and translate towards the vial 190 through the cap 1010. In some embodiments, the cap 1010 and piston 1050 can include a mechanism that allows the piston 1050 to translate when it is rotated relative to the cap 1010. The translational movement of the piston 1050 (for example, distal translation through the cap 1010 towards the vial 190) can generate a positive pressure and/or cause fluid stored in the vial 190 to flow out of the vial 190 through the vial adaptor 1000.

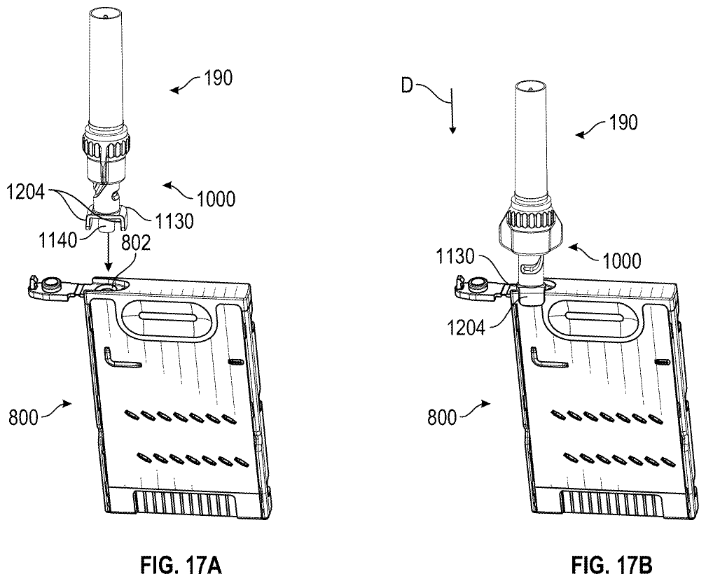

The piston 1050 can include a proximal end (for example, an end opposite the vial 190 as shown in FIG. 10A) that can removably couple with an opening of a target sensing device or a diagnostic device (for example, see FIGS. 17A and 17B).

FIG. 11 illustrates an exploded view of the vial adaptor 1000 and the vial 190. The cap 1010 can include a distal end 1114 (for example, an end that is proximate to the vial 190) and a proximal end 1116 (for example, an end that is distal from the vial 190). The proximal end 1116 can include an opening dimensioned to receive the piston 1050. The distal end 1114 can include an opening dimensioned to couple with the vial 190. For example, the distal end 1114 of the cap 1010 can include an inner surface having the threaded portion 1520 (see FIG. 15B). Additionally, the distal end 1114 of the cap 1010 can extend over at least a portion of the threaded portion 290 of the vial 190 when coupled to the vial 190. The coupling between the vial 190 and the cap 1010 can be leak-proof to prevent or inhibit fluid stored in the vial 190 from leaking during the transfer process. The cap 1010 can include one or more wings 1112. The wings 1112 may assist a user in tightening the cap 1010 onto and/or removing the cap 1010 from the threaded portion 290 of the vial 190. The cap 1010 can include furrows 1118. The furrows 1118 can help a user grip and/or rotate the cap 1010.

The vial 190 can include the threaded portion 290 and a protrusion 292. The protrusion 292 can engage the distal end 1114 of the cap 1010 and stop further distal translation of the cap 1010.

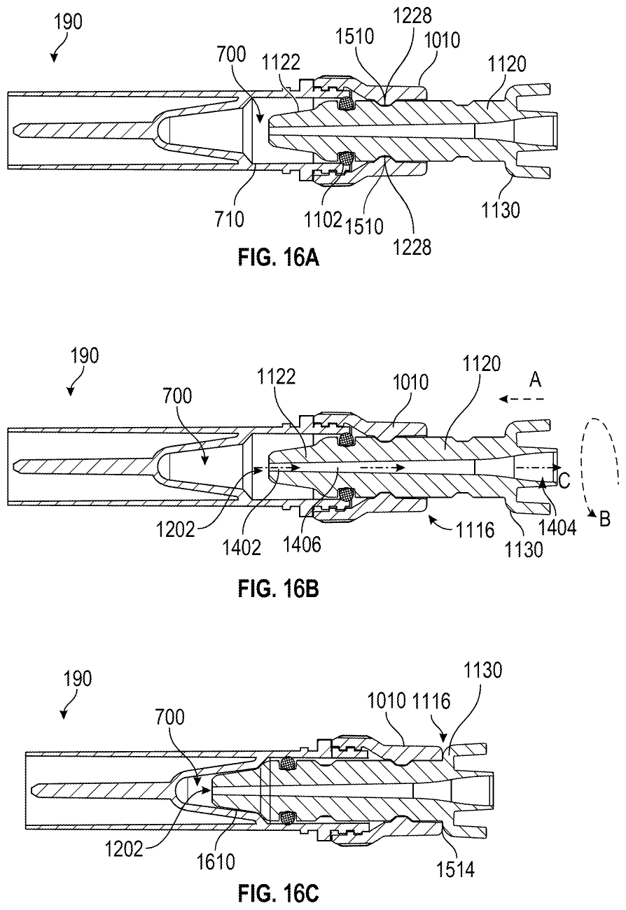

The piston 1050 can include a seal 1102 and a piston body 1120. The seal 1102 and the piston body 1120 can be removably coupled. The seal 1102 can be positioned on and/or within an indentation 1104 of the piston body 1120. The seal 1102 can be dimensioned such that its outer circumference 1106 can abut against an inner surface (for example, inner surface 710 shown in FIG. 16A) of the vial 190 to create a watertight barrier. The watertight barrier between the inner surface 710 of the vial 190 and the outer circumference 1106 of the seal 1102 can be maintained while the piston 1050 is distally translated through the cap 1010 towards the vial 190. Additionally, the watertight barrier between the inner surface 710 of the vial 190 and the outer circumference 1106 of the seal 1102 can prevent or inhibit fluid stored in the vial 190 from leaking between the seal 1102 of the cover 1100 and the inner surface 710 of the vial 190 during use. Additionally, the barrier between the inner surface 710 of the vial 190 and the outer circumference 1106 of the seal 1102 can generate a positive pressure gradient or volume displacement in the vial 190, which can cause fluid stored in the vial 190 to flow out of the vial 190 via the vial adaptor 1000.

In some embodiments, the seal 1102 can be made from a material that can generate desired amount of friction against the inner surface 710 of the vial 190 (for example, inner surface 710 shown in FIG. 16A). In some embodiments, the seal 1102 can include an elastomer.

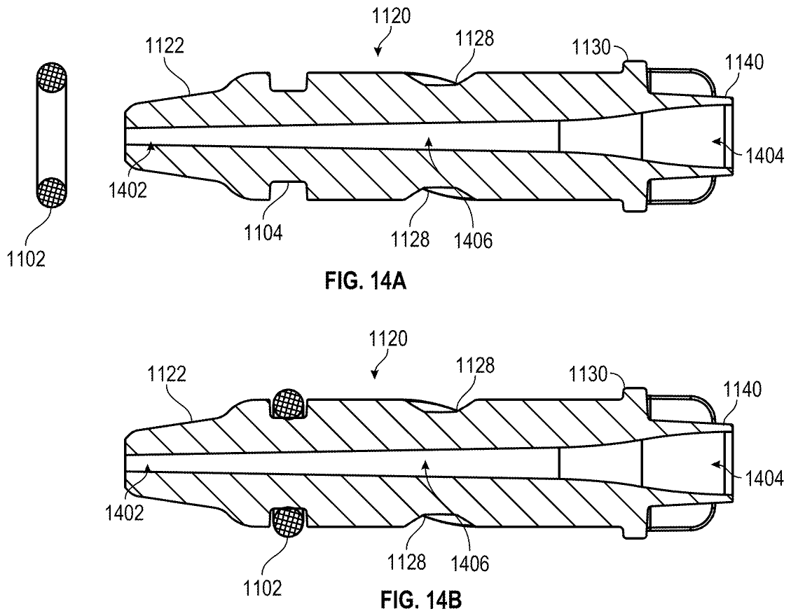

The piston body 1120 of the piston 1050 can include a head 1122, a groove 1128, a stopper 1130, and a proximal portion 1140. The head 1122 can include a distal end 1124. The distal end 1124 can be shaped such that when the head 1122 is inserted into the vial 190, the distal end 1124 matches the interior surface of the vial 190. Conformance between the head 1122 and the interior surface of the vial 190 can aid in causing all and/or substantially all of the fluid stored in the vial 190 to flow through a channel 1406 (as shown in FIGS. 14A and 14B) of the piston body 1120 when the piston 1050 is actuated towards the vial 190.

The groove 1128 can be formed on the piston body 1120. In some embodiments, there are one, two, three, four, five or six grooves 1128 formed on the piston body 1120, though other numbers of grooves 1128 may be suitably implemented. The embodiment depicted in FIGS. 10A-17B includes two grooves 1128. The groove 1128 can be formed in the piston body 1120 to follow a spiral, helical, and/or screw-like path, running along at least a portion of the length of the piston body 1120 while running along at least a portion of the outer circumference of the piston body 1120. The groove 1128 can engage a detent of the cap 1010 (for example, detent 1510 shown in FIGS. 15A and 15B). When engaged, the groove 1128 and the detent can cause the piston 1050 to translate relative to the cap 1010 when the piston 1050 rotates relative to the cap 1010. The groove 1128 can include locks 1126a and/or 1126b that can engage the detent (for example, detent 1510 shown in FIGS. 15A and 15B) of the cap 1010 to at least partially restrict the movement of the piston 1050 through the cap 1010 and/or to provide tactile feedback. Each of locks 1126a and 1126b may include one or more ridges that can slightly or substantially inhibit motion of a detent of the cap 1010 past the lock 1126a and/or 1126b. To twist the piston 1050 such that the detent 1510 travels beyond the lock 1126a and/or 1126b, the user can exert a threshold force. The threshold force may be larger than a force ordinarily needed to twist the piston 1050 when the lock 1126a and/or 1126b is not engaged by the detent 1510 of the cap 1010. In some embodiments, the piston 1050 includes a lock 1126a corresponding to a pre-actuation position of the piston 1050 relative to the cap 1010. In such embodiments, the user can exert at least the threshold force on the piston 1050 to move the detent past the lock 1126a to initiate actuation of the piston 1050. The lock 1126a may provide a user with tactile feedback that actuation of the piston 1050 has begun. In some embodiments, the piston 1050 includes a lock 1126b corresponding to a post-actuation position of the piston 1050 relative to the cap 1010. In such embodiments, the user can exert at least the threshold force on the piston 1050 to move the detent past the lock 1126b to complete actuation. The lock 1126b may provide a user with tactile feedback that actuation of the piston 1050 is complete. In some embodiments, there may be additional locks along the groove 1128. Such additional locks may provide tactile feedback to a user that a particular intermediate volume of fluid has been deployed from the vial 190.

The stopper 1130 can extend radially outward from an outer circumference of the piston body 1120 proximate to the proximal portion 1140. The stopper 1130 can engage the proximal end 1116 of the cap 1010 to prevent further movement (for example, distal translation) of the piston 1050 with respect to the cap 1010 (for example, through the cap 1010). Additionally, the stopper 1130 can abut against an opening of a testing device (e.g., a cartridge for sensing and/or identifying pathogens, genomic materials, proteins, and/or other small molecules or biomarkers) or another storage device (for example, for fluid samples) during use such that fluid stored in the vial 190 can be transferred to the testing device or the other storage device via the vial adaptor 1000.

In some embodiments, the piston 1050 and the cap 1010 may be integrated into a single device, with the piston 1050 being able to move (for example, translate distally or proximally and/or rotate) with respect to the cap 1010.

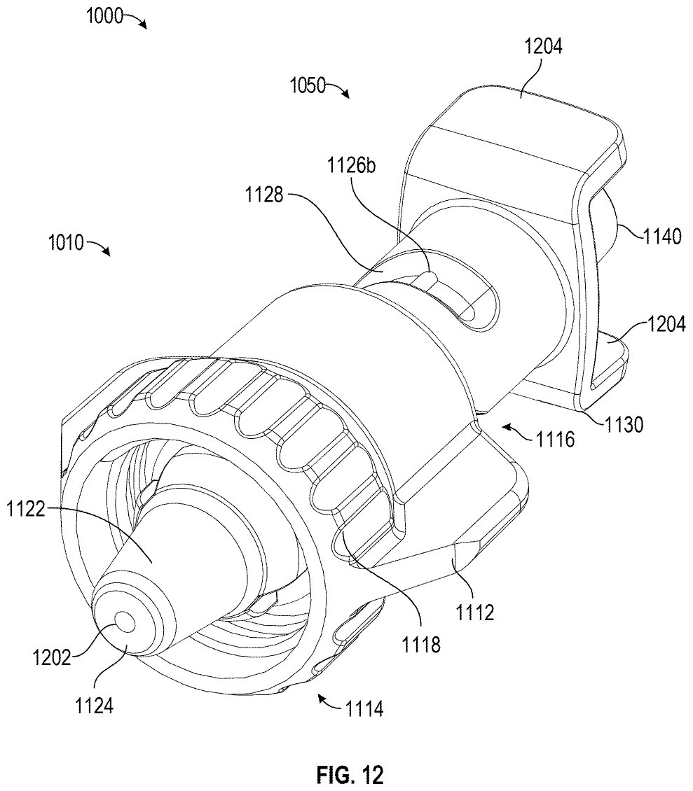

FIG. 12 illustrates a perspective view of the vial adaptor 1000. The piston 1050 can include a distal aperture 1202 formed on a distal end 1124 of the head 1122. During use, as the piston 1050 distally translates towards the vial 190, the head 1122 and the distal aperture 1202 can move, for example, into a cavity 700 (see FIGS. 16A-16C) of the vial 190. As the head 1122 moves into the cavity (for example, the cavity 700) of the vial 190, it displaces the volume of the cavity and generates a positive pressure change in the vial 190. Coupled with the water-tight barrier between the seal 1102 and the inner surface (for example, the inner surface 710) of the vial 190, the distal movement of the piston 1050 can cause flow of fluid stored in the vial 190 via the distal aperture 1202 and out of the vial 190 via the vial adaptor 1000. In some embodiments, at least a portion of the head 1122 and the distal aperture 1202 extends into a portion of the vial 190.

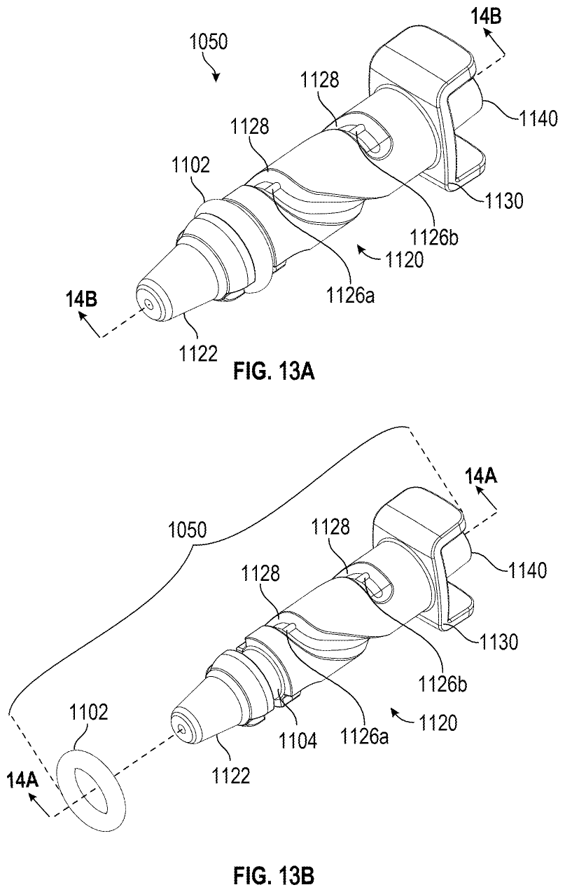

With references to FIGS. 13A-14B, the seal 1102 can be removably coupled with head 1122 of the piston body 1120. The seal 1102 may be an o-ring. The shape and dimensions of the indentation 1104 can correspond to the shape of seal 1102. The indentation 1104 can prevent the seal 1102 from slipping off the head 1122 of the piston body 1120.

With reference to FIGS. 14A-14B, the piston body 1120 can include a distal opening 1402, a proximal opening 1404, and a channel 1406 extending and formed between the distal opening 1402 and the proximal opening 1404.

In some embodiments, the width of the channel 1406 can be uniform along the length of the piston 1050 or vary along the length of the piston 1050. For example, the width of the channel 1406 can, as shown in FIGS. 14A and 14B, gradually increase from the distal opening 1402 to the proximal opening 1404. In another example, the width of the channel can remain substantially the same between the majority of the channel 1406 between the distal opening 1402 and the stopper 1130, and increase significantly at the proximal portion 1140. The gradual increase of the width of the channel 1406 can facilitate flow through the channel 1406.

As described herein and shown in FIG. 14A, the piston body 1120 can include grooves 1128. The grooves 1128, when engaged with detents of the cap 1010, can cause the piston 1050 to translate relative to the cap 1010 due to rotational motion relative to the cap 1010. The grooves 1128, when engaged with detents of the cap 1010, can cause the piston 1050 to rotate relative to the cap 1010 due to translational motion of the piston 1050 relative to the cap 1010.

FIGS. 15A and 15B illustrate various views of the cap 1010 of the vial adaptor 1000. The cap 1010 can include a proximal opening 1500, a distal opening 1502, an inner circumference 1504, detents 1510, a first end 1514a threaded portion 1520, and wings 1112. The proximal opening 1500 can be dimensioned to receive the piston 1050. The distal opening 1502 can be dimensioned to, for example, extend over at least a portion of the vial 190 (for example, the threaded portion 290 of the vial 190). The threaded portion 1520 can be formed on an inner surface of the distal opening 1502 and can couple with a corresponding threaded portion (for example, the threaded portion 290) of the vial 190. As described herein, the interaction between the threaded or interlocking portion 1520 of cap 1010 and the threaded or interlocking portion 290 of the vial 190 can allow the cap 1010 of the vial adaptor 1000 to removably couple with the vial 190.

The detents 1510 can be shaped to engage with grooves of the piston. The detents can be positioned on an inner circumference 1504 of the cap 1010. The detents 1510 may have a conical shape. The detents 1510 may be conical in shape with a rounded or flattened top 1512, as shown in FIGS. 15A and 15B. The cap 1010 may include the same number of detents 1510 as grooves on the piston 1050. In embodiments with two detents, the detents 1510 can be arranged opposite each other within the interior surface of the cap arranged (i.e. 180° from each other on the circumference of an interior surface of the cap). In embodiments with three or more detents, each detent 1510 can be arranged equidistant from the proximate detents (i.e. detents are (360/n)° from each other on the circumference of an interior surface of the cap, where n is the total number of detents).

In some embodiments, the detent 1510 and groove 1128 can each be shaped and/or formed from a material that can generate desired amount of friction when the detent 1510 and groove 1128 slidingly contact.

FIGS. 16A-16C illustrate cross-sectional views of the vial adaptor 1000, showing different positions of the piston 1050 during use and motion of components of the vial adaptor 1000 and fluid contained therein. FIG. 16A illustrates relative position of the piston 1050 of the vial adaptor 1000 with respect to the vial 190 and the cap 1010 prior to actuation (for example, distal translation of the piston 1050 towards the vial 190). Prior to actuation, at least a portion of the piston 1050 (for example, the head 1122) may be positioned inside the vial 190. Additionally, the outer circumference of the piston 1050 (for example, the outer surface of the seal 1102) can abut against the inner surface of the vial 190 to provide water-tight barrier between the inner surface of the vial 190 and the piston 1050. The water-tight barrier can prevent or inhibit flow of fluid stored in the vial 190 being diverted into a space between the cap 1010 and the piston body 1120 of the piston 1050. In some embodiments, the detents 1510 the cap 1010 can be engaged by locks 1126b within the grooves 1128 of the piston 1050.

FIGS. 16B and 16C illustrates relative position of the piston 1050 with respect to the vial 190 and the cap 1010 during distal translation of the piston 1050. As described herein, the piston 1050 (or the piston body 1120 of the piston 1050) can be actuated and/or translated distally towards the vial 190 (for example, as indicated by a directional arrow A). When the piston 1050 moves in the direction A, the head 1122 of the piston 1050 moves further into the vial 190. This causes a positive pressure change and/or volume displacement in the vial 190, which causes a flow of fluid stored in the vial 190 out of the vial 190 via the distal aperture 1200 of the cover 1100, the distal opening 1402, the channel 1406, and the proximal opening 1404 (for example, as indicated by directional arrows B).

When the piston 1050 is fully actuated (for example, at its distal-most position with respect to the cap 1010), the stopper 1130 of the piston 1050 can abut against the proximal end 1116 of the cap. Additionally, the detent 1511 may engage the lock 1126b when the piston 1050 is fully actuated.

With reference to FIGS. 17A and 17B, the vial adaptor 1000 can be used to transfer, for example, fluid stored in the vial 190 to a receiving device 1700. The proximal portion 1140 of the piston 1050 can be inserted into an opening 1702 of the receiving device 1700. To prevent accidental leak from the vial 190 via the vial adaptor 1000, the vial 190 and the vial adaptor 1000 can be oriented to have the vial 190 positioned below the vial adaptor 1000 while the proximal portion 1140 is being coupled to the opening 1702 of the receiving device 1700. In some embodiments, the proximal portion 1140 and the opening 1702 can be coupled via friction fit. In some embodiments, the proximal portion 1140 and the opening 1702 can have corresponding attachment features (for example, threads) that allow the proximal portion 1140 and the opening 1702 to be removably secured to each other.

Once the vial 190 and the vial adaptor 1000 are coupled to the receiving device 1700, the receiving device 1700 can be positioned below the vial 190 and the vial adaptor 1000. The piston 1050 can then be translated towards the cap 1010 by, for example, rotating the piston 1050 relative to the cap 1010, thereby causing the vial 190 and the cap 1010 to translate towards the receiving device 1700. Pushing the vial 190 and the cap 1010 towards the receiving device 1700 can cause the head 1122 of the piston 1050 to move towards or into the vial 190 to generate positive pressure and/or volume displacement in the vial 190. The positive pressure and/or volume displacement in the vial 190 can cause flow of, for example, fluid stored in the vial 190 to the receiving device 1700.

Method of Using Vial Adaptor with Rotating Piston

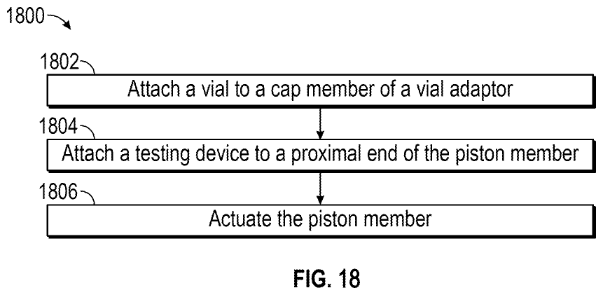

FIG. 18 illustrates an example method 1800 of transferring fluid from a vial (for example, the vial 190) to a receiving device 800 (for example, a testing device) using the vial adaptor 1000. At step 1802, a vial (for example, the vial 190) is attached to the cap 1010 of the vial adaptor 1000. For example, as described herein, the vial 190 can include a threaded portion 290 that can be screwed into the threaded portion 1520 of the cap 1010.

At step 1804, an opening of a receiving device 800 (for example, a testing device or a cartridge) is coupled to the proximal portion 1140 of the piston 1050. In some embodiments, the opening 802 of the receiving device 800 and the proximal portion 1140 can have corresponding coupling features (for example, threads, snap-fit, or a single thread and lock coupling) that allow the piston 1050 to be removably secured to the opening 802 of the receiving device 800. In some embodiments, the proximal portion 1140 of the piston 1050 can be coupled to the opening 802 of the receiving device 800 via friction fit. At step 1806, the piston 1050 is actuated. As described herein, the piston 1050 may be actuated by rotating the piston 1050 relative to the cap 1010 and vial 190, thereby distally translating the piston 1050 towards the vial 190 due to the interaction of the detents 1510 of the cap 1010 and the grooves 1128 of the piston body 1120. When the piston 1050 moves towards the vial 190, the movements of the head 1122 and the seal 1102 along the inner surface of the vial 190 can generate positive pressure and/or volume displacement in the vial 190, which can in turn generate flow out of the vial 190, through the piston 1050 and into the receiving device 800. In some embodiments, in order to facilitate the flow out of the vial 190, into the piston 1050, and into the receiving device, the vial 190, the vial adaptor 1000, and the receiving device (for example, the receiving device 800) may be positioned as shown in FIGS. 17A and 17B.

### Terminology

Herein, discussion of movement of the piston relative to the cap and/or vial could alternatively be discussed as movement of the cap and/or vial relative to the piston. For example, if the piston is rotated relative to the cap, the cap is rotated relative to the piston.

The term “comprising” as used herein is synonymous with “including,” “containing,” or “characterized by,” and is inclusive or open-ended and does not exclude additional, unrecited elements or method steps. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The articles “a” and “an” are used herein to refer to one or to more than one (for example, at least one) of the grammatical object of the article. By way of example, “an element” means one element or more than one element.

The terms “about” or “around” as used herein refer to a quantity, level, value, number, frequency, percentage, dimension, size, amount, weight or length that varies by as much as 30, 25, 20, 15, 10, 9, 8, 7, 6, 5, 4, 3, 2 or 1% to a reference quantity, level, value, number, frequency, percentage, dimension, size, amount, weight or length.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention.

All references cited herein, including but not limited to published and unpublished applications, patents, and literature references, are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

### Examples

Disclosed herein are additional examples of systems and methods described herein. Any of the examples in this disclosure may be combined in whole or in part. Any of the systems described in the examples may implement any of the methods, processes, and/or the like described herein and any of the methods described in the examples may be implemented by any of the systems described herein. Some aspects of the embodiments discussed above are disclosed in further detail in the additional examples, which are not in any way intended to limit the scope of the present disclosure. Those in the art will appreciate that many other embodiments also fall within the scope of the invention, as it is described herein above and in the claims. Any of the examples may include fewer or greater components or steps. Further, components and/or method steps described in the examples can be replaced with other components and/or method steps.

Example 1. A vial adaptor configured to facilitate transfer of fluid from a vial to a receiving device, the vial adaptor comprising:
a cap comprising a proximal opening, a distal opening, at least one detent, and a threaded portion configured to removably couple with a corresponding threaded portion formed on an opening of a vial; and
a piston comprising a distal end, a proximal end, a channel, and a body extending between the distal end and the proximal end and comprising a head, the piston configured to abut an inner surface of the vial, the channel extending between the distal end and the proximal end of the piston and configured to allow flow of fluid through the piston between the distal end and the proximal end, the body comprising at least one groove configured to contact the at least one detent, the at least one groove configured to cause the piston to translate in a first direction relative to the cap when the piston is rotated relative to the cap, translation of the piston in the first direction configured to cause a positive pressure change in the vial and withdrawal of fluid stored in the vial through the channel of the piston.

Example 2. The vial adaptor of Example 1, wherein the first direction is a direction towards the vial.

Example 3. The vial adaptor of any one of Examples 1 or 2, wherein the at least one groove comprises one or more locks configured to secure the piston in place relative to the cap.

Example 4. The vial adaptor of Example 3, wherein the one or more locks comprise a first lock, the first lock configured to lock the piston at a first position relative to the cap and a second lock, the second lock configured to lock the piston at a second position relative to the cap.

Example 5. The vial adaptor of Example 4, wherein the first position is a pre-actuation position and the second position is a post-actuation position.

Example 6. The vial adaptor of any one of Examples 3-5, wherein at least one of the one or more locks comprises a ridge disposed within the at least one groove.

Example 7. The vial adaptor of any one of Examples 1-6, wherein the piston further comprises a seal configured to abut an interior surface of the vial.

Example 8. The vial adaptor of claim 7, wherein the seal comprises an elastomer.

Example 9. The vial adaptor of any one of Examples 1-8, wherein the proximal end of the piston is configured to removably couple with a receiving device.

Example 10. The vial adaptor of any one of Examples 1-9, wherein the piston comprises a stopper extending radially and circumferentially outwards from the body of the piston, wherein the stopper is configured to abut the cap when the piston is in a distal-most position with respect to the cap.

Example 11. The vial adaptor of any one of Examples 1-10, wherein a width of the channel increases from the distal end of the piston to the proximal end of the piston.

Example 12. A vial adaptor comprising:
a cap configured to removably couple with an opening of a vial; and
a piston comprising a distal end, a proximal end, a body extending between the distal end and the proximal end, and a channel, the channel configured to allow flow of fluid through the piston between a distal aperture formed on the distal end of the piston and a proximal aperture formed on the proximal end of the piston, the piston configured rotate and thereby translate distally through the cap and towards the vial;
wherein a distal translation of the piston is configured to cause a positive pressure change in the vial and withdrawal of fluid stored in the vial through the channel of the piston.

Example 13. The vial adaptor of Example 12, wherein the cap comprises a detent, wherein the piston comprises a groove, and wherein the detent is configured to engage the groove to allow rotation of the piston relative to the cap to cause distal translation of the piston through the cap towards the vial.

Example 14. The vial adaptor of Example 13, wherein the groove comprises a first lock, the first lock configured to prevent motion of the piston relative to the cap absent a threshold force imparted by a user.

Example 15. The vial adaptor of Example 14, wherein the groove comprises a second lock, wherein the first lock is configured to secure the piston in a pre-actuation position absent a threshold force imparted by the user, and wherein the second lock is configured to secure the piston in a post-actuation position and configured to provide a user with tactile feedback that actuation of the piston is complete.

Example 16. The vial adaptor of any one of Examples 12-15, wherein the proximal end of the piston is configured to removably couple with a receiving device.

Example 17. The vial adaptor of any one of Examples 12-16, wherein the piston comprises a stopper extending radially and circumferentially outwards from the body of the piston, wherein the stopper is configured to abut the cap when the piston is in a post-actuation position with respect to the cap.

Example 18. The vial adaptor of any one of Examples 12-17, wherein a width of the channel increases from the distal aperture to the proximal aperture.

Example 19. The vial adaptor of any one of Examples 12-18, further comprising a seal, wherein the seal is configured to wrap about at least a portion of the distal end of the body of the piston.

Example 20. The vial adaptor of Example 19, wherein the seal comprises an o-ring, the o-ring comprising an elastomer.

Example 21. The vial adaptor of any one of Examples 19-20, wherein the seal is configured to abut an inner surface of the vial to create a watertight barrier between the seal and the inner surface of the vial.

Example 22. A piston for withdrawing fluid stored in a vial, the piston comprising:
a distal end;
a proximal end;
a body extending between the distal end and the proximal end, the body comprising a head comprising a distal aperture, the proximal end comprising a proximal aperture;
a channel formed within the body and extending between the distal aperture and the proximal aperture; and
a groove formed on an exterior surface of the body and extending along at least a portion of a length of the body, the groove configured to contact a detent;
the head of the piston configured to move towards and into a vial and generate a positive pressure change in the vial, thereby causing a flow of fluid stored in the vial into the channel via the distal aperture and out of the channel via the proximal aperture.

Example 23. The piston of Example 22, wherein a width of the channel increases from the distal aperture to the proximal aperture.

Example 24. The piston of any one of Examples 22-23, wherein the groove spirals about at least a portion of the circumference of the body.

Example 25. The piston of Example 24, wherein the groove comprises a lock.

Example 26. The piston of Example 25, wherein the lock comprises a ridge positioned within the groove.

Example 27. The piston of any one of Examples 22-26, wherein the piston is configured to move through a proximal opening and a distal opening of a cap, and wherein the cap is configured to be attached to an opening of the vial.

Example 28. The piston of any one of Examples 22-27, the piston comprising a seal.

Example 29. The piston of Example 28, wherein the seal is configured to cover at least a portion of the distal end of the piston, and wherein an outer circumference of the seal is configured to abut an inner surface of the vial thereby create a watertight barrier between the seal and the vial.

Example 30. The piston of any one of Examples 28-29, wherein the seal comprises an elastomer.

Example 31. The piston of any one of Examples 22-30, wherein the proximal end of the piston is configured to removably couple with a receiving device.

Example 32. A method of withdrawing fluid stored in a vial via a vial adaptor, the method comprising:
coupling a distal opening of a cap of a vial adaptor to an opening of a vial, the cap comprising a proximal opening opposite of the distal opening;
coupling a proximal end of a piston of the vial adaptor to an opening of a receiving device;
rotating the piston relative to the cap and the vial, thereby causing distal translation of the piston towards the vial and through the proximal opening and the distal opening of the cap, the piston configured to abut an inner surface of the vial to create a watertight barrier between the piston and the inner surface of the vial, the distal translation of the piston towards the vial thereby generating a positive pressure change in the vial causing a flow of fluid stored in the vial through a channel of the piston.

Example 33. The method of Example 32, wherein the piston comprises a seal, the seal covering at least a portion of a distal end of the piston.

Example 34. The method of any one of Examples 32-33, wherein the cap comprises a detent and the piston comprises a groove configured to engage the detent, and wherein rotation of the piston causes the detent to travel along a path defined by the groove, thereby causing distal translation of the piston relative to the cap.

Example 35. The method of Example 34, comprising rotating the piston past a pre-actuation position, wherein, at the pre-actuation position, the detent is engaged by a first lock.

Example 36. The method of any one of Examples 34-35, comprising rotating the piston to a post-actuation position, wherein, at the post-actuation position, the detent is engaged by a second lock.

Example 37. The method of any one of Examples 32-36, wherein the channel extends between a distal aperture formed about a distal end of the piston and a proximal aperture formed about the proximal end of the piston.

Example 38. The method of any one of Examples 32-37, wherein the piston comprises a stopper.

Example 39. The method of Example 38, wherein the stopper is configured to abut the cap when the piston is in its post-actuation position.

Example 40. The method of any one of Examples 38-39, wherein the stopper is configured to abut the receiving device when the proximal end of the piston is coupled to the opening of the receiving device.

What is claimed is:

1. A vial adaptor configured to facilitate transfer of fluid from a vial to a receiving device, the vial adaptor comprising:
a cap comprising a proximal opening, a distal opening, at least one detent, and a threaded portion configured to removably couple with a corresponding threaded portion formed on an opening of a vial; and
a piston comprising a distal end, a proximal end, a channel, and a body extending between the distal end and the proximal end and comprising a head, the piston configured to abut an inner surface of the vial, the channel extending between the distal end and the proximal end of the piston and configured to allow flow of fluid through the piston between the distal end and the proximal end, the body comprising at least one groove configured to contact the at least one detent, the at least one groove configured to cause the piston to translate in a first direction relative to the cap when the piston is rotated relative to the cap, translation of the piston in the first direction configured to cause a positive pressure change in the vial and withdrawal of fluid stored in the vial through the channel of the piston.

2. The vial adaptor of claim 1, wherein the first direction is a direction towards the vial.

3. The vial adaptor of claim 1, wherein the at least one groove comprises one or more locks configured to secure the piston in place relative to the cap.

4. The vial adaptor of claim 3, wherein the one or more locks comprise a first lock, the first lock configured to lock the piston at a first position relative to the cap and a second lock, the second lock configured to lock the piston at a second position relative to the cap.

5. The vial adaptor of claim 3, wherein at least one of the one or more locks comprises a ridge disposed within the at least one groove.

6. The vial adaptor of claim 1, wherein the piston further comprises a seal configured to abut an interior surface of the vial.

7. The vial adaptor of claim 1, wherein the proximal end of the piston is configured to removably couple with a receiving device.

8. The vial adaptor of claim 1, wherein the piston comprises a stopper extending radially and circumferentially outwards from the body of the piston, wherein the stopper is configured to abut the cap when the piston is in a distal-most position with respect to the cap.

9. A vial adaptor comprising:
a cap configured to removably couple with an opening of a vial; and
a piston comprising a distal end, a proximal end, a body extending between the distal end and the proximal end, and a channel, the channel configured to allow flow of fluid through the piston between a distal aperture formed on the distal end of the piston and a proximal aperture formed on the proximal end of the piston, the piston configured rotate and thereby translate distally through the cap and towards the vial;
wherein a distal translation of the piston is configured to cause a positive pressure change in the vial and withdrawal of fluid stored in the vial through the channel of the piston.

10. The vial adaptor of claim 9, wherein the cap comprises a detent, wherein the piston comprises a groove, and wherein the detent is configured to engage the groove to allow rotation of the piston relative to the cap to cause distal translation of the piston through the cap towards the vial.

11. The vial adaptor of claim 10, wherein the groove comprises a first lock, the first lock configured to prevent motion of the piston relative to the cap absent a threshold force imparted by a user.

12. The vial adaptor of claim 11, wherein the groove comprises a second lock, wherein the first lock is configured to secure the piston in a pre-actuation position absent a threshold force imparted by the user, and wherein the second lock is configured to secure the piston in a post-actuation position and configured to provide a user with tactile feedback that actuation of the piston is complete.

13. The vial adaptor of claim 9, wherein the piston comprises a stopper extending radially and circumferentially outwards from the body of the piston, wherein the stopper is configured to abut the cap when the piston is in a post-actuation position with respect to the cap.

14. The vial adaptor of claim 9, further comprising a seal, wherein the seal is configured to wrap about at least a portion of the distal end of the body of the piston.

15. The vial adaptor of claim 14, wherein the seal is configured to abut an inner surface of the vial to create a watertight barrier between the seal and the inner surface of the vial.

16. A method of withdrawing fluid stored in a vial via a vial adaptor, the method comprising:
coupling a distal opening of a cap of a vial adaptor to an opening of a vial, the cap comprising a proximal opening opposite of the distal opening;
coupling a proximal end of a piston of the vial adaptor to an opening of a receiving device;
rotating the piston relative to the cap and the vial, thereby causing distal translation of the piston towards the vial and through the proximal opening and the distal opening of the cap, the piston configured to abut an inner surface of the vial to create a watertight barrier between the piston and the inner surface of the vial, the distal translation of the piston towards the vial thereby generating a positive pressure change in the vial causing a flow of fluid stored in the vial through a channel of the piston.

17. The method of claim 16, wherein the piston comprises a seal, the seal covering at least a portion of a distal end of the piston.

18. The method of claim 16, wherein the cap comprises a detent and the piston comprises a groove configured to engage the detent, and wherein rotation of the piston causes the detent to travel along a path defined by the groove, thereby causing distal translation of the piston relative to the cap.

19. The method of claim 18, comprising rotating the piston past a pre-actuation position, wherein, at the pre-actuation position, the detent is engaged by a first lock.

20. The method of claim 18, comprising rotating the piston to a post-actuation position, wherein, at the post-actuation position, the detent is engaged by a second lock.
